(19) United States
(12) Patent Application Publication
(10) Pub. No.: US 2001/0041088 A1
(43) Pub. Date: Nov. 15, 2001

(54) COMPUTER KEYBOARD COVER PACKAGE

(76) Inventors: CHERYL B. LEBEAU, JACKSONVILLE, FL (US); SHERRY L. TILLMAN, JACKSONVILLE, FL (US)

Correspondence Address: ARTHUR G YEAGER PA, 112 WEST ADAMS STREET, SUITE 1305, JACKSONVILLE, FL, 32202

(21) Appl. No.: 09/303,632

(22) Filed: May 3, 1999

(51) Int. Cl. B41J 5/08; B41J 5/10; B41J 5/12

(52) U.S. Cl. 400/691; 400/713; 400/714; 400/496

(57) ABSTRACT

Disposable transparent covers for a computer keyboard that are adapted to be left on the keyboard for short periods of time so as to protect against diseases when the keyboard is being manipulated by laboratory and/or dental technicians and to protect against accumulations of dust and dirt that might incapacitate a computer. Preferably, the covers come in a package and are replaced after each patient. The covers may be detachably secured to the keyboard or generally envelopes same.

### CROSS REFERENCE TO RELATED APPLICATIONS

Not Applicable.

### FEDERALLY SPONSORED RESEARCH OR DEVELOPMENT

Not Applicable.

### BACKGROUND OF THE INVENTION

1. Field of the Invention

This invention relates to personal computers and their equipment, and more particularly, to disposable covers for keyboards used with computers in dental and medical fields to maintain the keyboards' sterility.

2. Related Art

The only known related art is that dealing with permanent covers for typewriters and other keyboard machines having typewriter keyboards.

### BRIEF SUMMARY OF THE INVENTION

A package of disposable transparent sterile covers used to protect the keyboard from collecting accumulations of contaminants that might be transmitted between patients and/or render the computer inoperable; the cover being a sheet of transparent, highly flexible plastic film that overlies the keys and the frame of the keyboard and forms a barrier against the contaminants and their supporting levers and arms. In specific embodiments thereof the sheet of plastic film may be adherent to the keyboard frame by means of a tacky adhesive on the portions of the sheet; and/or the sheet may be part of an envelope or a tubular sleeve that encases the top and the bottom of the keyboard.

### BRIEF DESCRIPTION OF THE DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top plan view of a typical prior art keyboard of a computer used in the dental or medical fields;

FIG. 2 is an end elevational view of the prior art keyboard of FIG. 1;

FIG. 3 is a top plan view similar to FIG. 1 with a single sheet disposable cover protecting the keyboard according to a first embodiment of this invention;

FIG. 4 is an end elevational view of the protected keyboard of FIG. 3;

FIG. 5 is a top plan view of a package of single sheet covers employed in the combination of FIGS. 3 and 4;

FIG. 6 is a top plan view of the keyboard of FIGS. 1 and 2 being inserted into an envelope cover according to a second embodiment of this invention;

FIG. 7 is a cross-sectional view taken at 7—7 of FIG. 6;

FIG. 8 is a top plan view of the keyboard of FIGS. 1 and 2 being inserted into a tubular cover according to a third embodiment of this invention; and

FIG. 9 is an end elevational view of the cover and keyboard of FIG. 8.

### DETAILED DESCRIPTION OF THE INVENTION

This invention is a handy disposable and transparent cover that is employed to maintain an operational keyboard of a personal computer in a sanitary condition and in working order. One of the principal enemies of a computer is dust or dirt that may foul the moving parts of the keyboard, and accordingly, it is important to keep those parts as free from such contamination as possible. In some instances the fear of contamination has been so critical to the operation of the keyboard that the computer had to be contained in a dust-free atmosphere that was a very expensive installation. Personal computers for home and family use have become so commonplace that computers are operated in all sorts of atmospheres regardless of their sensitivity to dust. At the same time the computers have been greatly improved and made less sensitive to dirty atmospheres. Accordingly, it is usually thought to be sufficient protection against dust contamination merely to drape a cloth or other cover over the keyboard when it is not in use. It is an object of this invention to provide a keyboard cover that does not have to be removed every time the computer is placed in operation, and then put back over the keyboard when computer is shut down. This invention permits the operator to forget about the keyboard cover except when a deliberate cleaning procedure is undertaken. For normal everyday operations the operator employing this invention merely turns on the computer and starts typing commands, and when he or she is finished, the computer is turned off. There is no need to take off a dust cover or put one on the keyboard; these operations are no longer necessary. The covers of this invention remain in place over the keyboard all the time regardless of whether the computer is in operation or at rest. It is, of course, always possible for the cover to be removed entirely from the keyboard should the operator wish to do so; or if the keyboard is being used by different operators, as at a library or other public place, or even at offices where different persons share the use of a computer.

This invention envisions portable packages of clear keyboard covers that may be carried in a pocket or purse, and readily produced to provide a sanitary cover whenever necessary or desirable. There are three principal styles of covers that may be selected by the operator, and the packages of this invention may enclose only a single style or a mixture of two or three of these styles, depending on the merchandiser's choice of how best to market the covers. These covers are particularly useful in medical or dental offices where patients need to be protected against contamination.

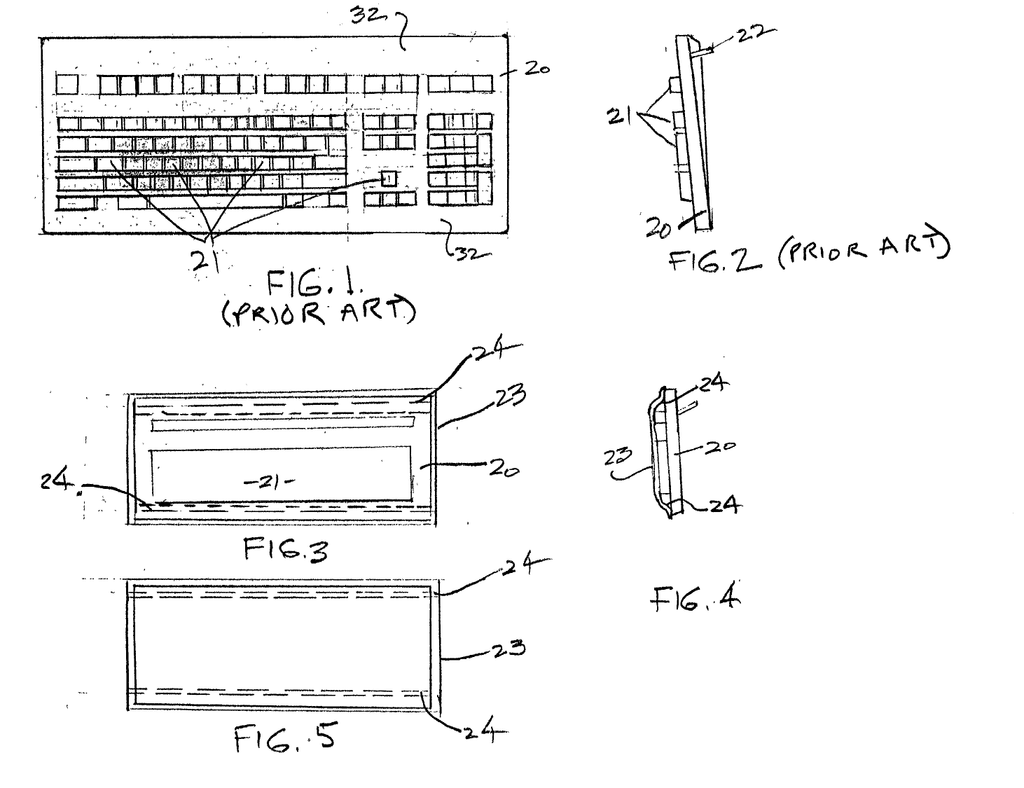

In FIG. 1 of the attached drawings there is shown a typical prior art keyboard layout of the various letters, numbers, and symbols found on most keyboards of modern computers. It is, of course, the prerogative of the computer designer to select which and how many letters, numbers, and symbols to employ. Different computers may have slightly different keyboards, but generally, they all will be quite similar in size and content, thus making the keyboard covers of this invention also similar in size and shape. The keyboard 20 comprises a frame 32 with a number of holes or openings through which keys 21 extend upwardly with a face having embossed thereon a letter, number, or a symbol. The face is touched by the operator's finger to cause the computer usually to show on its screen the letter, number, or symbol of the touched key. The spaces between the keys 21 and the frame 32 are dust catchers which should be protected to prevent any buildup of dust that might interfere with the operation of the computer. In accordance with this invention a thin film of clear plastic material 23 is draped over and fastened to keyboard 20 to intercept any and all dust settling around the keys 21. That dust can be brushed off the cover 23 and allowed to fall to the floor. Most keyboards are enclosed by the frame 32 which covers substantially all of the lower surfaces of the keyboard, including the levers that connect each key 21 to a transmitter that causes the appropriate letter, number, or symbol to appear on the screen. Generally the only opening on the bottom of the frame 32 is for one or two folding legs 22 that provide a tilting keyboard face for the comfort of the operator.

In FIGS. 3-5 there are shown three views of a transparent disposable single-sheet cover 23 employed to protect a keyboard 20. Cover 23 is sufficiently large to overlie the upper surface of the keyboard 20 and extend a bit beyond the outer edges of the keyboard. The cover has two parallel strips of adhesive on the inner surface of the cover; i.e., the surface that faces and touches the upper surface of the keyboard. The adhesive employed on this cover should be that which merely prevents the cover from sliding laterally, but does not form a tight cohesive bond with the keyboard frame or the keys. The adhesive should form only a temporary bond to the keyboard so that it may permit the cover to be easily removed from the keyboard when not needed and yet may be sufficiently tacky to attach the cover to the keyboard the next time the cover is used without applying any more adhesive to the cover. There are rubbery adhesives that can be applied to the cover in a thin line and are capable of lightly bonding the cover to the keyboard and will remain intact when the cover is stripped from the keyboard ready for future use without applying any additional adhesive. A package of covers 23 is illustrated in FIG. 5 and indicated by numeral 33.

In FIG. 4 it may be seen that the cover 23 is sufficiently wide that it completely encloses the upper surfaces of the keyboard so as to prevent any dust from the atmosphere from settling in the narrow spaces around the keys. Two lines of adhesive 24 are shown on the cover 20 and positioned so as to contact the keyboard frame 32 and not interfere with the operation of any key. The lateral edges of the cover may extend beyond the lateral sides of the keyboard so as to lie flat on the surface supporting the keyboard. Generally this arrangement will prevent any floating dust from settling on the keyboard. It is, however, contemplated that in some instances the operator may wish to trim the cover edges to some limits so that the cover may be adhered to the keyboard frame without extending beyond the face of the keyboard.

In FIGS. 6-9 there are two other embodiments of covers shown. Both of these embodiments employ two sheets of plastic film, in contrast to that shown in FIGS. 3-5 where the cover includes only a single sheet of clear thin plastic film. The cover 25 in FIGS. 6 and 7 is an envelope having three closed sides 31 and one open side 26 into which the keyboard 20 is shown to be entering in FIGS. 6 and 7. The open side 26 is not shown to be closable by any specific means in these drawings, but it should be apparent that open side 26 can be closed by the use of adhesive strips near the open edge; by spaced snaps or zipper means, by Velcro tapes, or the like. Generally, the open side may be a sufficient barrier to dust by simply allowing the open sides to rest quietly by gravity against each other. The envelope style of this embodiment may be prepared by folding a single sheet of plastic film against itself and heat-sealing two edges to produce the envelope. The same envelope can be produced by cutting two pieces of film to the same size and heat-sealing along three sides of the cut film. Many different films may be employed for this embodiment, such as polyethylene, polypropylene, polyacrylonitrile, polyester, polyfluorocarbons, and the like. It is preferable that the film be transparent, tough, and reasonably limp in thickness of about 1-3 mils.

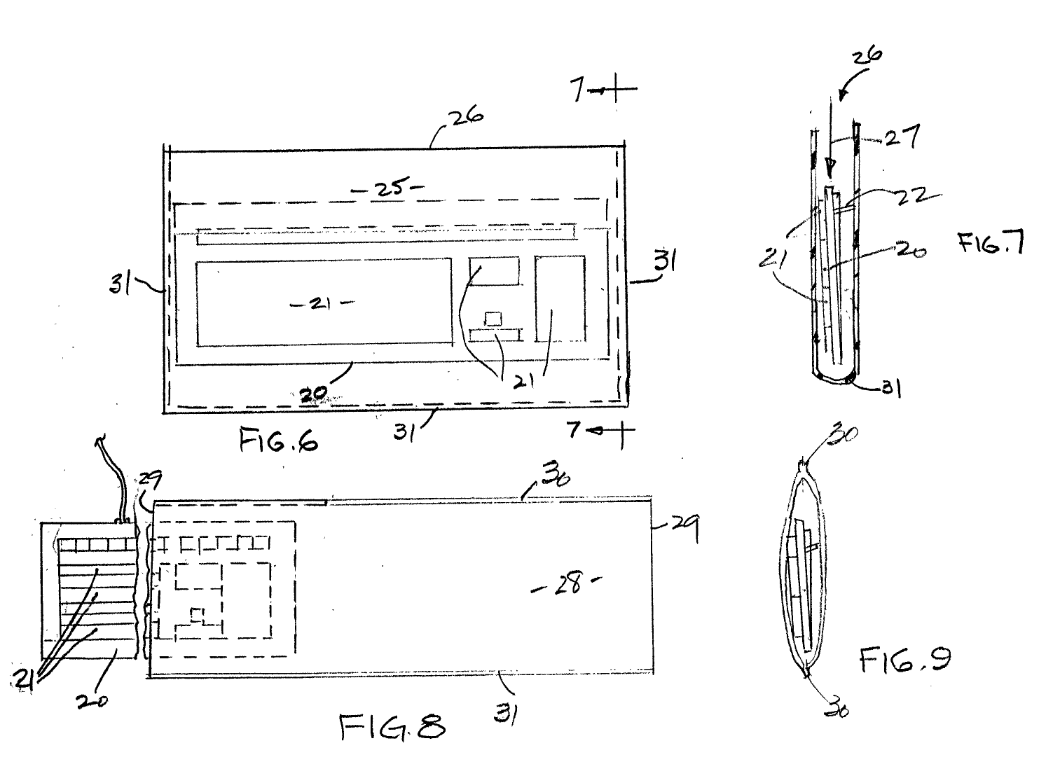

A third style of cover is desirable in some embodiments of this invention, and this style is shown in FIGS. 8 and 9 of the drawings. This style is a tubular sleeve into which an end of the keyboard may slide. As explained above with respect to the style of FIGS. 6 and 7, this cover may be made by folding a sheet of film to make two layers and heat-sealing one edge to make a tubular cover with two open ends into which the keyboard may be introduced. The same tubular cover can be made from two identical rectangular pieces of film that are heat-sealed along two parallel opposite sides so as to result in a tubular cover with two opposite open ends into which the keyboard may be slid to be covered on both top and bottom by separate layers of the film. If the tube is long enough, the open ends will automatically collapse onto each other and form a reasonably good seal against the entry of contamination that might foul the working parts of the keyboard.

The covers of this invention must be transparent in order to allow the letters, numbers, or symbols on the keys to be readily seen. Some typists know their keyboard so well that they need not see a key to know which letter, number, or symbol it represents, but this skill is not common to most computer operators, and so it is necessary that the cover be transparent so as to readily identify which key to strike. It has already been mentioned that the adhesive which attaches the cover to the keyboard frame should be tacky to attach the cover to the keyboard, but it should be sufficiently easy to separate the film from the keyboard without destroying the adhesive. This allows the cover to be attached and removed numerous times without destruction of the film or the adhesive if the cover is used in a non-sterile environment. These are competing features and there will be times when it will be necessary to throw away a used cover and employ a new cover to prevent the spread of contamination. There is also a choice to be made by the user of film thickness to be used for the cover. Some typists have a very light touch when striking a key, and such a typist might which to select a heavier or lighter film gauge for the cover so as to interfere as little as possible with the touch and feel of the typist operating the keys. A heavier thickness might interfere with striking the keys by a typist with a light touch. Any typist with a heavy touch might tend to cause two keys to operate when only one was intended. Still other reasons may be present to individual typists when selecting the film thickness preferred. In any event, the covers of this invention can be made in different thicknesses so as to suit the desires of each individual typist. However, flexibility and cost of the film may be factors to consider, e.g., the thinnest and least costly film may be preferable if the cover is to be used for only one patient and then thrown away in favor of a film of longer life.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A package of disposable transparent covers for protecting a keyboard of a computer, each said cover comprising a transparent sheet of pliable plastic film of a predetermined size to protect the entire upper surface of the keyboard, said sheet inhibiting any unintentional contact between the keyboard while not impeding the operator's ability to manipulate the keyboard in a speedy and accurate manner.

2. The package of claim 1 wherein said sheet is rectangular, having a long top edge portion, a long bottom edge portion, and two short side edge portions, a strip of adhesive along at least said top edge portion adapted to be attached along said top edge portion of said keyboard.

3. The package of claim 1 further including a pair of spaced strips of adhesive along respective said top and bottom edge portions adapted to be attached along elongated upper and lower portions of the upper surface of the keyboard.

4. The package of claim 1 wherein said sheet protects the entire upper and lower surfaces of the keyboard.

5. The package of claim 1 wherein said sheet is formed with an upper member and a lower member, said upper member being adapted to overlie the upper surface of the keyboard and said lower member being adapted to underlie the bottom surface of the keyboard.

6. The package of claim 4 wherein said sheet is formed as an envelope with an elongated opening along an elongated top edge portion.

7. The package of claim 4 wherein said sheet is formed as an envelope with an elongated opening adjacent one corner and extending along one side edge portion and generally to a midpoint along a top edge portion.

8. The package of claim 1 wherein said cover is formed from two identical flat sheets of plastic film having an elongated top edge portion, an elongated bottom edge portion, and two short side edge portions, said sheets being fastened together along said bottom edge portion of each so as to envelope the entire upper and lower surfaces of the keyboard.

9. The package of claim 8 wherein said two identical flat sheets of said plastic film are fastened together along each of said side edge portions with one long opening along a top edge portion to permit the keyboard to be inserted therein so as to cover both the upper and bottom surfaces of the keyboard.

10. The package of claim 8 wherein said two identical flat sheets of plastic film are fastened together along both said long edges so as to form an elongated envelope having at least one open short side edge portions.

11. The package of claim 10 wherein said top edge portions of said sheets adjacent said at least one open short side edge portions is open to generally its midpoint.

12. A disposable transparent cover for protecting a keyboard of a computer, comprising a transparent sheet of pliable plastic film of a predetermined size to protect the entire upper surface of the keyboard, said sheet inhibiting any unintentional contact between the keyboard and the fingers of the operator of the keyboard while not impeding the operator's ability to manipulate the keyboard in a speedy and accurate manner.

13. The cover of claim 12 wherein said sheet is rectangular, having a long top edge portion, a long bottom edge portion, and two short side edge portions, a strip of adhesive along at least said top edge portion adapted to be attached along said top edge portion of said keyboard.

14. The cover of claim 12 further including a pair of spaced strips of adhesive along respective said top and bottom edge portions adapted to be attached along elongated upper and lower portions of the upper surface of the keyboard.

15. The cover of claim 12 wherein said sheet protects the entire upper and lower surfaces of the keyboard.

16. The cover of claim 1 wherein said sheet is formed with an upper member and a lower member, said upper member being adapted to overlie the upper surface of the keyboard and said lower member being adapted to underlie the bottom surface of the keyboard.

17. The cover of claim 15 wherein said sheet is formed as an envelope with an elongated opening along an elongated top edge portion.

18. The cover of claim 15 wherein said sheet is formed as an envelope with an elongated opening adjacent one corner and extending along one side edge portion and generally to a midpoint along a top edge portion.

19. The cover of claim 1 wherein said cover is formed from two identical flat sheets of plastic film having an elongated top edge portion, an elongated bottom edge portion, and two short side edge portions, said sheets being fastened together along said bottom edge portion of each so as to envelope the entire upper and bottom surfaces of the keyboard.

20. The cover of claim 19 wherein said two identical flat sheets of plastic film are fastened together along each of said side edge portions with one long opening along a top edge portion to permit the keyboard to be inserted therein so as to cover both the upper and bottom surfaces of the keyboard.
